(19) United States
(12) Patent Application Publication
(10) Pub. No.: US 2013/0320180 A1
(43) Pub. Date: Dec. 5, 2013

(54) Bracket and Bracket Assembly

(71) Applicant: Invention Holdings Pty Ltd, West Burleigh (AU)

(72) Inventor: Peter Castellanos, West Burleigh (AU)

(73) Assignee: INVENTION HOLDINGS PTY LTD, West Burleigh (AU)

(21) Appl. No.: 13/957,704

(22) Filed: Aug. 2, 2013

Related U.S. Application Data
(63) Continuation-in-part of application No. 12/989,143, filed on Oct. 22, 2010, now Pat. No. 8,500,078.

(30) Foreign Application Priority Data
Apr. 24, 2008 (AU) 2008902025

(51) Int. Cl. F16M 13/02

(52) U.S. Cl. CPC F16M 13/02
USPC 248/534; 248/223.41; 248/200

(57) ABSTRACT

A modular bracket assembly includes a first mounting part to be mounted to a surface, this part having a sleeve for fixably receiving a second inserting part. The second inserting part has aperture adapted to receive a complementary attachment part

This application is a continuation-in-part application of U.S. patent application Ser. No. 12/989,143 filed on Apr. 22, 2010, now pending and incorporated by reference herein.

### TECHNICAL FIELD OF THE INVENTION

This invention relates to bracket assemblies for supporting various objects. In particular, the invention relates to a modular bracket for use in forming bracket assemblies for supporting various objects. The invention extends to a bracket assembly formed with the modular bracket.

### BACKGROUND OF THE INVENTION

A number of different types of brackets for supporting various objects are currently available and used. Typically, brackets are purpose made for applications.

There is an undoing need for alternative brackets that alleviate at least some limitations associated with conventional brackets for supporting objects.

### SUMMARY OF THE INVENTION

Accordingly, the invention provides a modular bracket, which includes:

a mounting portion adapted to be mounted to a surface;

an arm extending from the mounting portion; and

first coupling means at the free end of the arm for coupling to a further bracket member having complementary second coupling means for forming a bracket assembly.

The arm may include an upper arm portion and a lower arm portion and a coupling arm portion extending between the upper arm portion and lower arm portion, the coupling arm portion incorporating the first coupling means.

The upper arm portion may be longer than the lower arm portion and the coupling arm portion may extend between the upper arm portion and the lower arm portion at an acute angle relative to the upper arm portion. The lower arm portion may be angled towards the upper arm portion in the direction of the coupling arm.

The first coupling means may be configured to permit coupling with the second coupling means in a manner in which the further bracket member extends the arm longitudinally or in a manner in which the further bracket member extends at a right angle from the modular bracket.

The first coupling means and the second coupling means may be configured to permit coupling from a sideways direction relative to the lengthwise direction of the arm of the modular bracket.

The first coupling means and second coupling means may form a dovetail joint between the arm and the further bracket member.

The first coupling means may include the dovetail recess and the second coupling means may include the complementary male dovetail, the dovetail recess being sideways open to permit coupling from a sideways direction relative to the lengthwise direction of the arm of the modular bracket.

At least the upper arm portion and the lower arm portion may be of a T-shaped cross section.

The invention also provides a bracket assembly, which includes:

a modular bracket as defined above; and

a further bracket member which includes a holding formation for, in use, holding a complementary shaped object.

The modular bracket assembly may include any one or more of the optional features in accordance with the above aspect of the invention as herein defined, described, and illustrated.

The further bracket member may include an arm having the second coupling means towards one end and the holding formation towards the other end. The holding formation may include a hook formation.

Moreover, the further bracket member may include an elongated arm having the second coupling means at one end and the hook formation at the other end, the arm being oriented relative to the second coupling means so that that when coupled with the first coupling means of the bracket to form the bracket assembly, the arm being inclined outwardly and downwardly relative to the modular bracket.

The further bracket member may include an elongated arm having the second coupling means at one end and a plurality of holding formations provided on an elongated edge of the elongated arm.

The further bracket member may include an elongated arm having at least one holding formation provided on an elongated edge of the elongated arm, the holding formation being displaceable relative to the arm in a manner that accommodates a complementary shaped body of an object.

The invention further provides a modular bracket comprising a mounting portion adapted to be mounted to a surface, an arm extending from the mounting portion, and coupling means which includes a first coupling means at the free end of the arm for coupling to a further bracket member having complementary second coupling means for forming a bracket assembly.

The first coupling means and the second coupling means may form a dovetail joint between the arm and further bracket member. The coupling means may include a dovetail recess and a complementary male dovetail formation. The first coupling means may include a dovetail recess and the second coupling means may include the complementary male dovetail formation. The first coupling means may extend at an acute angle to the mounting portion. The dovetail recess may be formed on the arm or mounting portion and similarly the complementary male dovetail may be formed on the mounting portion or arm.

The mounting portion may include a mounting flange and the arm may extend in a plane normal to or at right angles from the mounting flange. The dovetail recess may be formed in a surface extending at an acute angle to the mounting flange. The arm may include an upper arm portion and a lower arm portion and a coupling arm portion extending between the upper arm portion and lower arm portion and including the dovetail recess. The terms “upper” and “lower” as used herein in relation to the arm portions define the position of the respective arm portions when the arm of the bracket is in an orientation extending substantially horizontally.

The upper arm portion may be longer than the lower arm portion and the coupling arm portion may extend at an acute angle, typically 45 degrees, to the upper arm portion. The lower arm portion may be angled upwardly towards the upper arm portion. The dovetail recess may extend longitudinally along the coupling arm portion. The arm portions may be of a T-shaped cross section which includes a web portion lying in a vertical plane and a flange portion extending substantially at right angles to the web portion. The web portion may also extend along the mounting portion.

The modular bracket may be coupled to the further bracket member which may be in the form of a hook member to form a bracket assembly for supporting bicycles or any other article. The hook member may have an arm, a hook at one end of the arm and the second coupling means at the opposite end of the arm for coupling to the first coupling means on the modular bracket. The hook member may be coupled to the modular bracket to extend outwardly there from and constitute an extension of the arm of the modular bracket for upright surface mounting. Alternatively, the hook member may be coupled to the modular bracket to extend at substantially right angles to the arm of the modular bracket, for ceiling or horizontal surface mounting.

The present invention thus in another aspect provides a bracket assembly for bicycles or other article comprising a modular bracket and a hook member described above.

The modular bracket may include any one or more of the optional features of the modular bracket member as herein defined, described, and illustrated.

The hook member in a further embodiment may include an elongated arm which terminates in a hook at one end with the second coupling means at it opposite end and oriented such that when coupled with the first coupling means of the modular bracket to form a bracket assembly, the hook member is inclined outwardly and downwardly relative to a horizontal plane from the modular bracket oriented for mounting to an upright surface.

A pair of bracket assemblies of this form may be arranged at a spaced part position and in substantially horizontal alignment for supporting a surfboard or any other elongated member.

The present invention thus in another aspect provides a bracket assembly for surfboards or other elongated member comprising a modular bracket and a hook member described above.

In another aspect, the modular bracket may be combined with a holder for forming a bracket assembly for supporting a plurality of fishing rods. The holder may include a first arm having the second coupling means at one end for coupling to the first coupling means of the modular bracket. The holder may also include a second arm having a plurality of hooks or other members for supporting respective fishing rods. The second arm may extend from the first arm at an acute angle to the first arm. The second arm may be attached at its lower end to the wall or upright surface. The second arm may terminate at its free end in a lug for attachment to a wall or other upright surface to form a brace.

The present invention thus in another aspect provides a fishing rod holder assembly comprising a pair of modular brackets and associated holders as described above adapted to be mounted at spaced part positions and in horizontal alignment with each other.

The bracket and other components of the bracket assemblies may be moulded from synthetic plastics material in an injection moulding process but may be manufactured using an alternative method.

### BRIEF DESCRIPTION OF THE DRAWINGS

In order that the invention may be more readily understood and put into practical effect, reference will now be made to the accompanying drawings which illustrate preferred embodiments of the invention, in which:

FIG. 1 shows a modular bracket, in accordance with the invention;

FIG. 2 is a front view of the bracket of FIG. 1;

FIG. 3 is a side view of the bracket of FIG. 1;

FIG. 4 shows in exploded view the bracket and an associated further bracket member for forming a bracket assembly, in accordance with the invention;

FIG. 5 shows the modular bracket and further bracket member of FIG. 4 in a first configuration for wall mounting;

FIG. 6 shows the modular bracket and connected further bracket member of FIG. 4 in a second configuration for ceiling mounting;

FIG. 7 shows in exploded view the modular bracket and associated further bracket member in a second embodiment;

FIG. 8 shows the modular bracket and connected further bracket member of FIG. 7;

FIG. 9 shows the modular bracket of FIGS. 1 to 3 with a connected holder for fishing rods;

FIG. 10 shows an alternative manner of mounting the modular bracket one above the other;

FIG. 11 shows another embodiment of a bracket assembly;

FIG. 12 shows the bracket assembly in FIG. 11, in use, holding hockey sticks;

FIG. 13 shows another embodiment of a bracket assembly;

FIG. 14 shows the bracket assembly of FIG. 13, in use, holding a rifle;

FIG. 15 shows another embodiment of a bracket assembly;

FIG. 16 shows the bracket assembly of FIG. 15, in use, holding a kayak and oar;

FIG. 17 shows a front view of first mounting part of a third embodiment of a modular bracket assembly;

FIG. 18 shows a side view of the first mounting part shown in FIG. 17;

FIG. 19 shows a rear view of the first mounting part shown in FIG. 17;

FIG. 20 shows a front isometric view of the first mounting part shown in FIG. 17;

FIG. 21 shows a rear isometric view of the first mounting part shown in FIG. 17;

FIG. 22 shows a front view of a second inserting part of the third embodiment of a bracket assembly;

FIG. 23 shows a rear view of the second inserting part shown in FIG. 22;

FIG. 24 shows a side view of the second inserting part shown in FIG. 22;

FIG. 25 shows a front isometric view of the second inserting part shown in FIG. 22;

FIG. 26 shows a back isometric view of the second inserting part shown in FIG. 22;

FIG. 27 shows a front view of a first mounting part of a fourth embodiment of a modular bracket assembly;

FIG. 28 shows a side view of the first mounting part shown in FIG. 27;

FIG. 29 shows a rear view of the first mounting part shown in FIG. 27;

FIG. 30 shows a front isometric view of the first mounting part shown in FIG. 27;

FIG. 31 shows a rear isometric view of the first mounting part shown in FIG. 27;

FIG. 32 shows a front view of a complimentary attachment part of a modular bracket assembly with two opposing walls;

FIG. 33 shows a side view of a complimentary attachment part of FIG. 32;

FIG. 34 shows an isometric view of a complimentary attachment part of FIG. 32;

FIG. 35 shows a front view of a complimentary attachment part of a modular bracket assembly with elongated protruding members;

FIG. 36 shows a side view of a complimentary attachment part of FIG. 35;

FIG. 37 shows a bottom view of a complimentary attachment part of FIG. 35;

FIG. 38 shows an isometric view of a complimentary attachment part of FIG. 35;

FIG. 39 shows a side view of a complimentary attachment part of a modular bracket assembly with second coupling means;

FIG. 40 shows a top view of a complimentary attachment part of FIG. 39;

FIG. 41 shows an isometric view of a complimentary attachment part of FIG. 39;

FIG. 42 shows a side view of a second inserting part of a fifth embodiment of a bracket assembly; and

FIG. 43 shows a front isometric view of the second inserting part of FIG. 42.

### DETAILED DESCRIPTION OF THE INVENTION

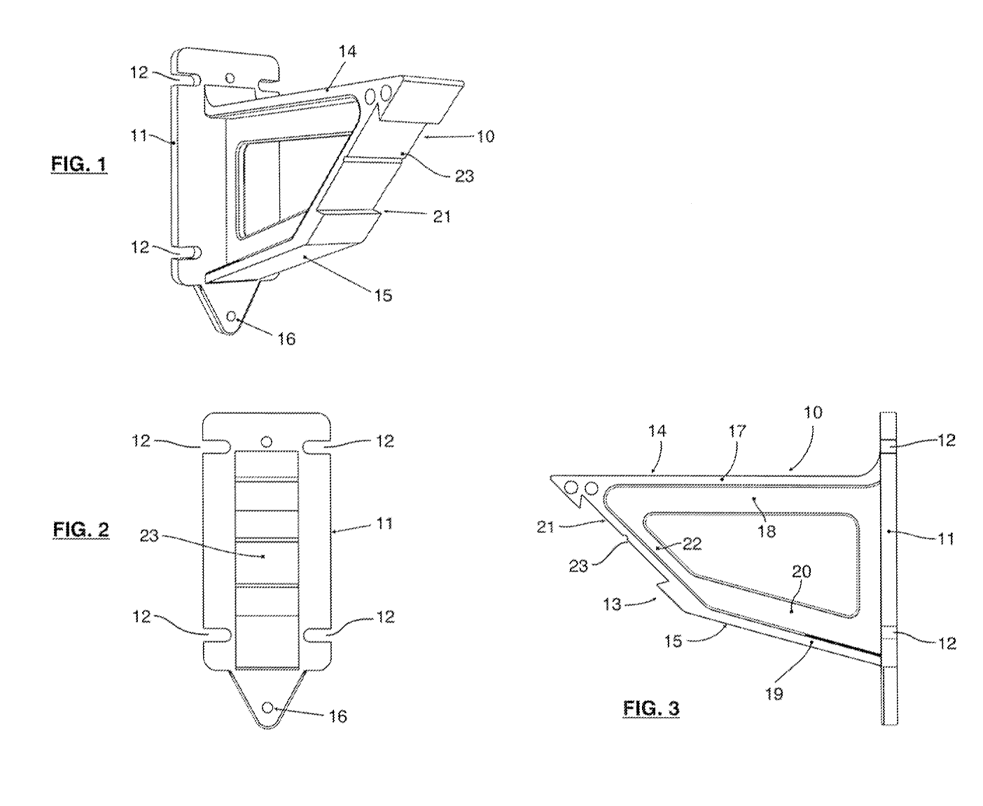

Referring to the drawings and firstly to FIGS. 1 to 3, there is illustrated a modular bracket 10 for use in forming bracket assemblies in accordance with the invention. The modular bracket 10 includes a planar mounting flange 11 which is adapted to be mounted to a vertical surface such as a wall surface or a horizontal surface such as a ceiling and which is provided with slots 12 in opposite side edges for receipt of screws or other fasteners for securing the flange 11 to the surface.

Extending outwardly from the flange 11 and substantially normal thereto is a bracket arm 13 which includes a first upper arm 14 and a spaced second lower arm 15 which is angled upwardly towards the upper arm 14. As is apparent, the base flange 11 has a portion 16 which extends downwardly below the lower arm 15 to provide additional support to the modular bracket 10 when secured to a mounting surface, the flange portion 16 being of a triangular tapered configuration. The upper arm 13 is of a T-shaped cross section including an upper flange 17 and a central supporting web or flange 18 extending from the underside thereof and the lower arm 15 is of a similar configuration including a lower flange 19 with a supporting flange or web 20 provided on the upper side thereof.

A coupling arm 21 extends between the outer ends of the upper arm 14 and lower arm 15 extending at an acute angle to the arm 14 and typically at 45 degrees to the arm 14. The coupling arm 21 includes a supporting web or flange 22 on its rear side which joins the flanges 18 and 20 to form a continuous stiffening flange for the arm assembly 13. The continuous stiffening web or flange also continues along the inner side of the base flange 11. The outer side of the arm 21 is provided with a dovetail shaped re-entrant recess 23 which has a width, the width of which extends longitudinally of the arm. The recess 23 is adapted to receive a complementary dovetail-shaped coupling of a further bracket member to be connected to the bracket 10 to adapt the bracket 10 for a number of different applications.

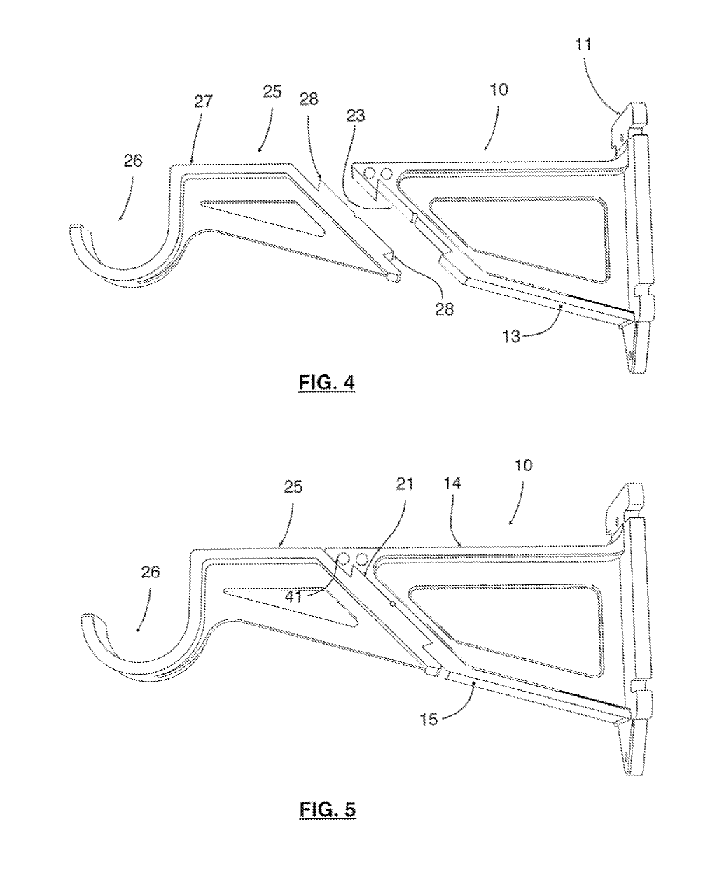

FIG. 4 is an exploded view showing the modular bracket 10 and associated further bracket member in the form of a hook member 25 for connection to the modular bracket 10, the hook member 25 having a hook 26 at one end, an arm 27 extending rearwards from the hook 26 and terminating in a coupling 28 for coupling to the bracket 10, the coupling 28 having a mail dovetail coupling formation 28′ complementary to the dovetail recess 23. The coupling 28 is angled at the same angle as the coupling arm 21 such that when the coupling formation 28′ is received in the recess 23 as in FIG. 5, the hook member 25 comprises a linear extension of the modular bracket 10 with the arm 27 comprising a continuous extension of the arm 13 of the modular bracket 10.

For connection, the coupling formation 28′ of the hook member 25 is slid sideways into the recess 23 so as to be retained therein. The connection suitably comprises a push or frictional fit such that the hook member 25 and modular bracket 10 are firmly interconnected. The arm 27 of the hook member 25 includes acutely angled upper and lower arm portions which connect to the hook 26 at one end and which are angled at the same angle as the arms 13 and 14 and effectively comprise extensions of the arms 13 and 14. At the coupling 28, the upper and lower arm portions are spaced apart substantially the same distance as the arms 13 and 14 at the coupling 23. The acutely angled arm 21 of the modular bracket 10 provides an enlarged surface to carry loads applied to the hook 26 and further distributes the load along both arms 14 and 15 to the wall surface to which the modular bracket 10 is mounted.

The modular bracket 10 with assembled hook member 25 forms a bracket assembly as shown in FIG. 5 which can be mounted to a vertical wall surface by suitably fasteners such as screws passed through the slots 12 into the wall. Where the wall is timber or where the modular bracket 10 is to be secured to a stud or other timber member, screws can be driven through the flange 11 and extension portion 16 thereof into the stud or other member. The bracket assembly is typically suited for storage of bicycles on a wall with the top rail of the bicycle being hooked over and being supported by the hook 26. Alternatively a pair of bracket assemblies as described may be mounted to a wall at spaced apart positions to support the top rail of the bicycle.

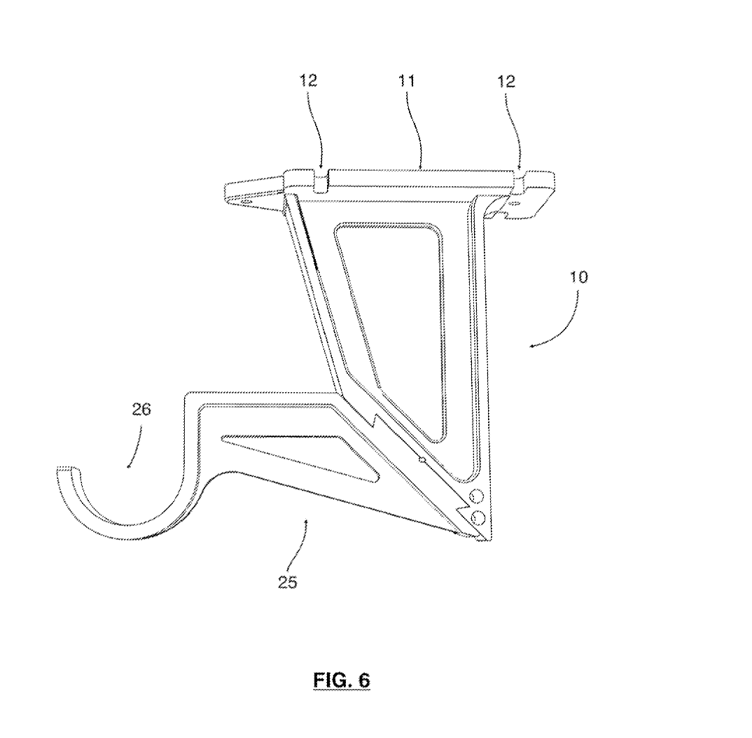

In the embodiment of FIG. 6, the hook member 25 is reversed from its attitude of FIGS. 4 and 5 such that when connected to the modular bracket 10, it extends substantially at right angles to the modular bracket 10. In this embodiment, the flange 11 of the modular bracket 10 may be secured to a ceiling or other horizontal surface by fasteners passed through the slots 12 and/or fasteners driven through the flange 11 and a bicycle may be hung from the hook 26 for example by its wheel.

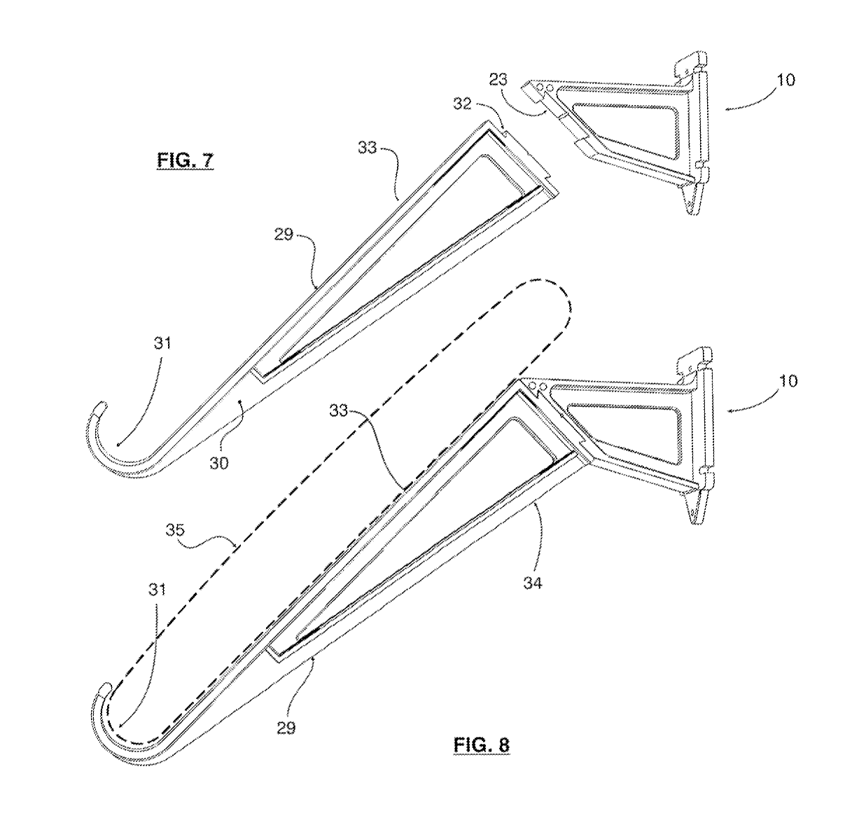

FIG. 7 illustrates the modular bracket 10 associated with a further embodiment of hook member 29 which includes an elongated arm 30 or similar configuration to the arm 27 terminating at one end in a hook 31 and at its opposite end in a coupling 32 of dovetail configuration adapted to be coupled to the modular bracket 10 via the dovetail recess 23. The coupling 32 however is angled in this case at approximately 90 degrees to the top surface 33 of the arm 30 such that when the coupling 32 is engaged in the recess 23 as shown in FIG. 8 to form the bracket assembly 34, the arm 30 is angled downwardly relative to a horizontal plane at an acute angle.

The bracket assembly 34 is particularly suited to mounting to a vertical surface such as a wall surface for supporting surfboards or other elongated members. Thus the respective modular brackets 10 of a pair of bracket assemblies 34 may be secured at spaced apart positions and in substantially horizontal alignment to a vertical wall surface such that the hook members 29 of the respective bracket assemblies 34 are inclined downwardly. A surfboard 35 shown in dotted outline in FIG. 8 may then be positioned on the respective top surfaces 33 of the arms 30 to be supported thereby and by the hook 31 at the end of the arms 30.

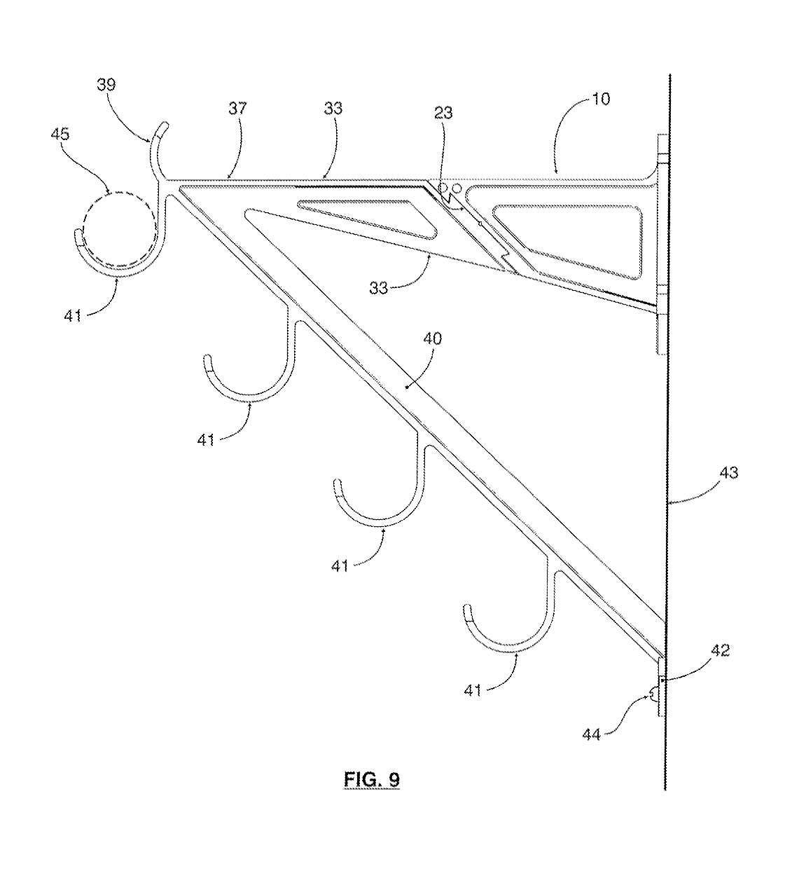

Referring now to FIG. 9, there is illustrated a further embodiment of the invention comprising a bracket assembly 36 for fishing rods or other elongated member and including a bracket 10 and a rod holder 36. The holder 36 includes an upper arm 37 which is similar to the arm 27 of the hook member 25 of FIG. 1 and which has a dovetail male coupling 38 for receipt in the dovetail recess 23 of the bracket 10 and which is angled such that the arm 37 extends substantially horizontally outwardly of the bracket 10. An upwardly extending hook 39 is proved at the outer end of the arm 37. A further return arm 40 extends from the outer end of the arm 37 and at an acute angle thereto, the arm 40 being formed integrally with the arm 37. A series of hooks 41 (in these case four hooks) are provided at spaced positions along the arm 40 and the arm 40 terminates at its lower end in a mounting lug 42. The hooks 41 are of arcuate form and open upwardly to form a support for an elongated member such as a fishing rod.

The modular bracket 10 may be secured to a vertical surface 43 as described above and the lug 42 may also be secured to the surface 43 such as by a screw or other fastener 44 passed through the lug 42 to support the arm 40 and form a bracing for the bracket assembly 35. It will be noted that the hooks 41 are offset horizontally from each another.

A pair of bracket assemblies 35 may be mounted to the wall surface 43 at spaced apart positions and in substantially horizontal alignment and respective fishing rods may be located in and supported by spaced hooks 41 as shown at dotted outline at 45. As the hooks 41 along the arm are offset from each other, the reel carried by one fishing rod will not interfere with the reel carried by an adjacent fishing rod.

While it is preferred that the arm 40 is attached by the lug 42 to a wall surface, this may not be necessary in all circumstances. The holder 35 in the preferred embodiment is moulded of plastics in an injection moulding process with the components integrally formed but it may be moulded or fabricated using other manufacturing processes. The holder 35 may also include any number of rood holding hooks 41 as is practical. A further rod or rods may also be supported on the arm 37 of the holder 35 to be retained by the hook 39 at the end of the arm 37. The hooks 41 may be replaced by other holding devices such as clips, clamps, or shelving members for holding or supporting other elongated articles.

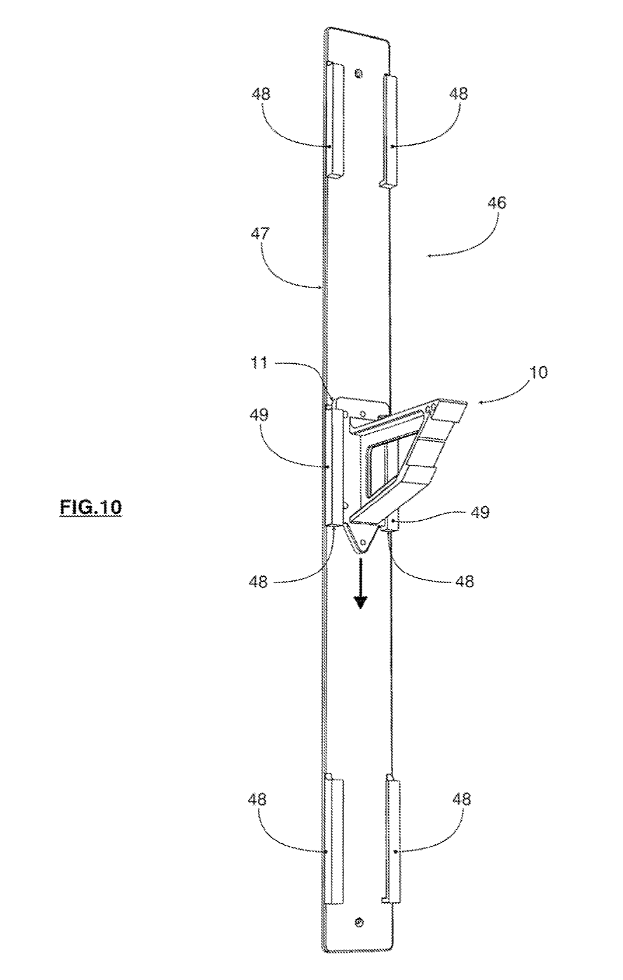

FIG. 10 illustrates an alternative manner of supporting a plurality of the modular brackets 10 one above the other. As shown a mounting bracket 46 having an elongated rectangular planar base flange 47 is proved along opposite edges with inwardly directed opposing L-shaped lugs 48 which define with the base flange channels into which the base flange 11 of a modular bracket 10 may be slid in the direction of the arrow in FIG. 10 to be captured between the lugs 48, the lugs 48 having stops 49 at their lower ends to provide support to the base flanges 11. In the illustrated embodiment, the bracket 46 has three sets of opposing lugs 48 and thus can carry three modular brackets 10 but may include any number of lugs 48. The bracket 46 may be secured in any suitable manner to a vertical surface such as by adhesives or fasteners driven through apertures in the flange 47. The bracket 46 may support spaced bracket assemblies of the type shown in FIGS. 4 and 5, 7 and 8 and 9.

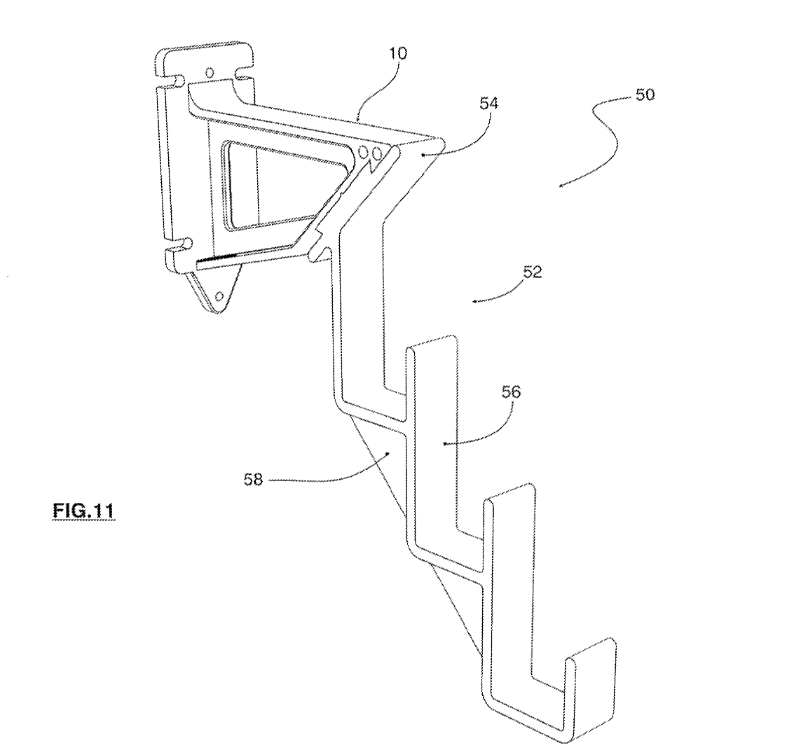

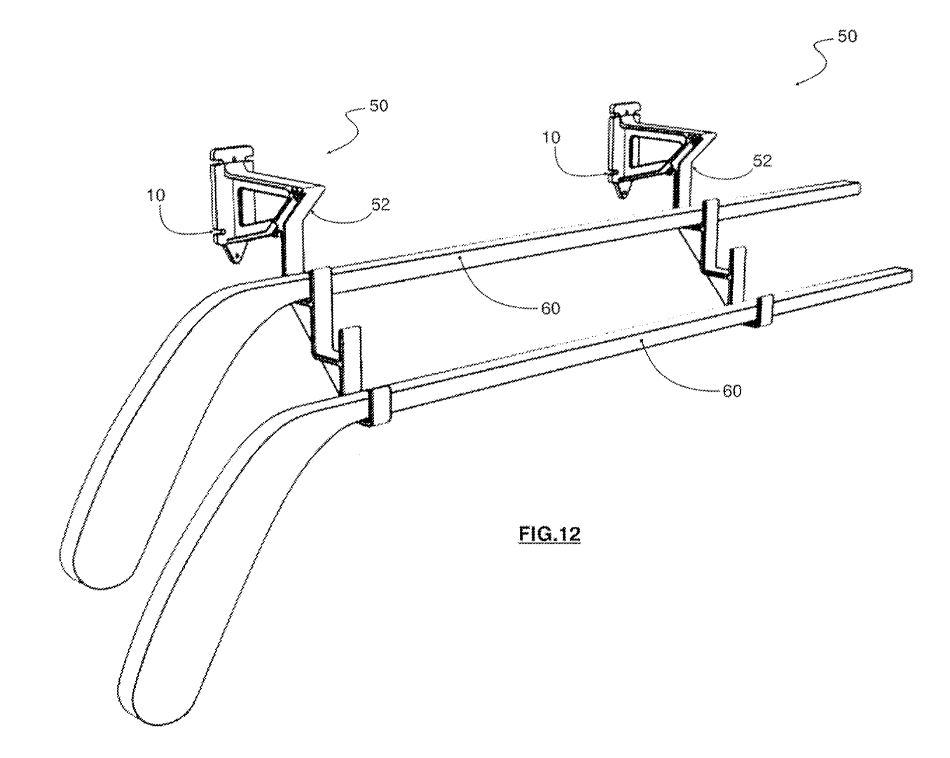

FIG. 11 shows another embodiment of a bracket assembly 50. The bracket assembly 50 includes the modular bracket 10 coupled to a further bracket 52. The further bracket 52 includes a coupling arm 54 that incorporates the male dovetail formation, and three holder formations 56 in form of three generally L-shaped hook formations that are arranged in a vertically staggered arrangement. An upper most hook formation is affixed to the coupling arm 54 in a relative orientation in which the three hood formations 56 depends downwards when the further bracket member 52 is coupled to the modular bracket 10. The further bracket member 52 also includes webs or gussets 58 for structural support. FIG. 12 shows the bracket assembly 50 in use holding hockey sticks 60.

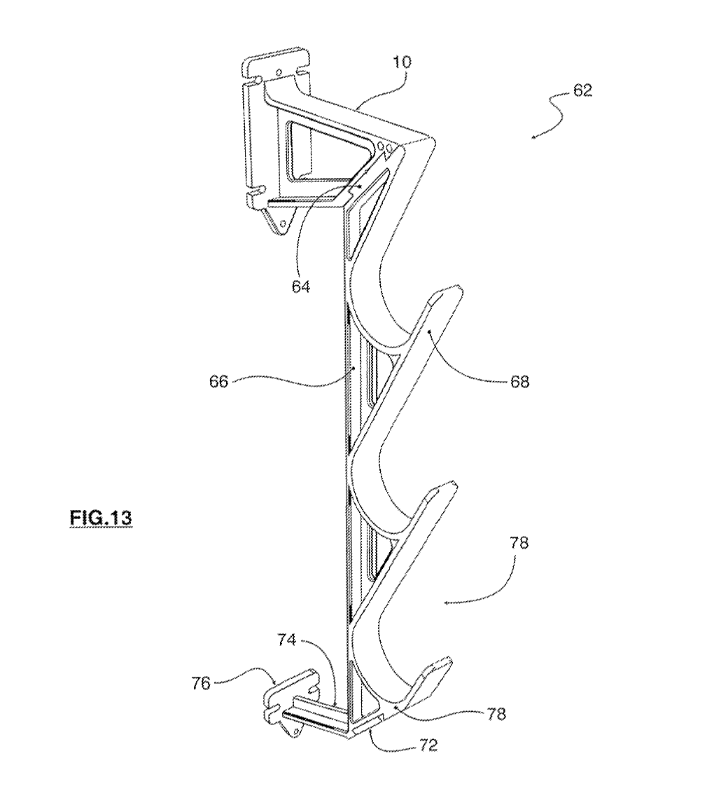

FIG. 13 shows another embodiment of a bracket assembly 62. The bracket assembly 62 includes the modular bracket 10 and a further bracket member 78. The further bracket member 78 includes a coupling arm 64 that incorporates the mail dovetail formation for coupling to the modular bracket 10. An elongated arm 66 extends from an end of the coupling arm 64 and is orientated so that it depends operatively downwards when the further bracket member 78 is coupled to the modular bracket 10. Three holding formations 68 are provided along the arm 66 in a staggered relationship. The further bracket member 78 also includes a further coupling arm 72 at its lower end for coupling, for example, with a further bracket member (not shown), so as to increase the number of available hook formations. Another arm 47 projects from a lower end of the arm 74, and terminates in a mounting bracket 76 for mounting to the support wall. The hook formations are shaped and sized complementary to a transverse shape of a portion of a rifle 88, so as to hold rifles in use as shown in FIG. 14.

FIG. 15 shows another embodiment of a bracket assembly 80. The bracket assembly 80 includes the modular bracket 10 coupled to a further bracket member 82. The further bracket member 82 includes a coupling arm 83 which incorporates the male dovetail formation. The further bracket member also includes an elongated arm 86 which projects away from the coupling arm 84 in an orientation in which the arm 84 forms a generally horizontal extension of the modular bracket 10.

The further bracket member 82 also includes two displaceable members 90, each being in the form of a slightly curved flat rocker arm that is pivotally mounted about a pivot pin 92 which extends between two opposing lugs 94 at either side of an upper long edge of arm 86. The two rocker arms 90 are spaced apart on the long side edge of the arm 86 and orientate so that their major working faces more-or-less face each other.

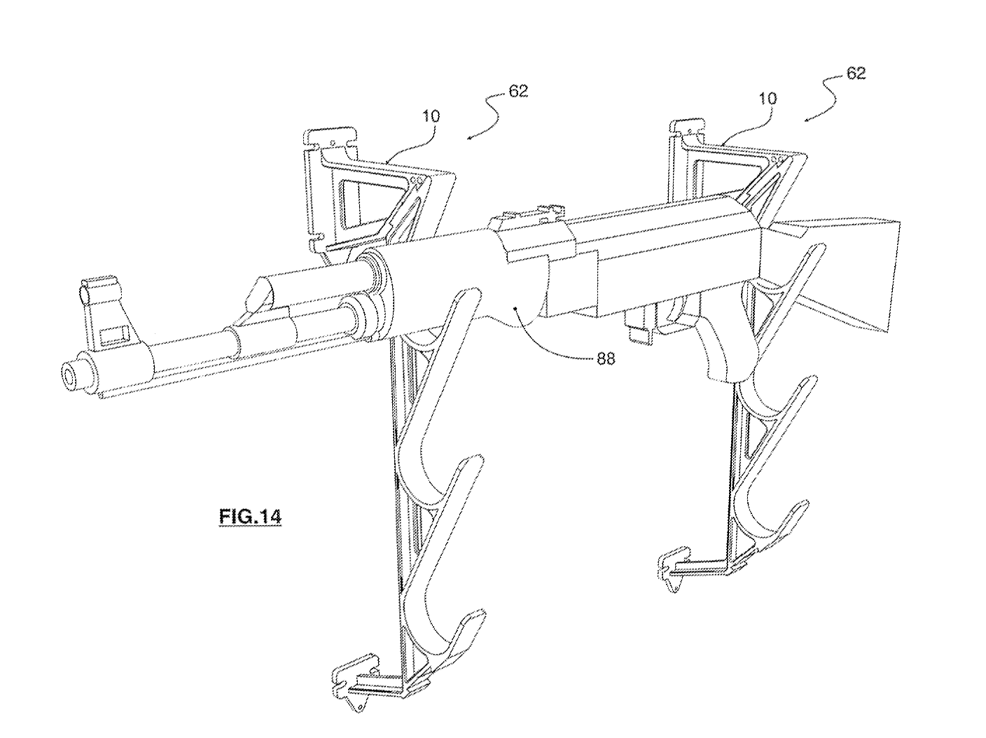

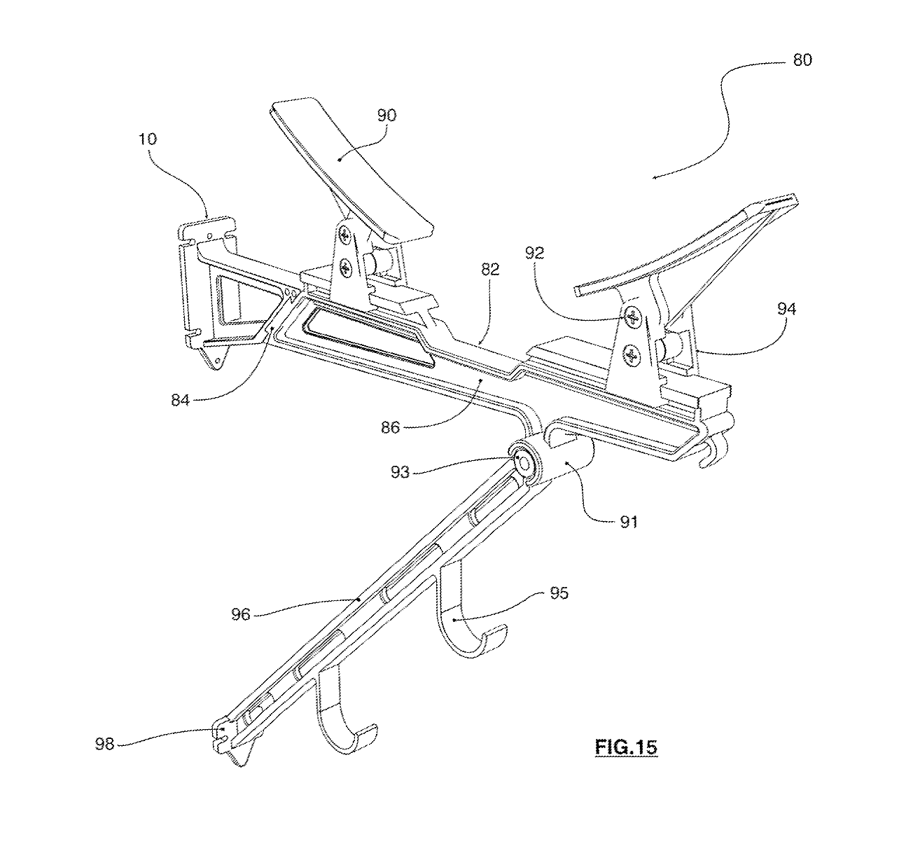

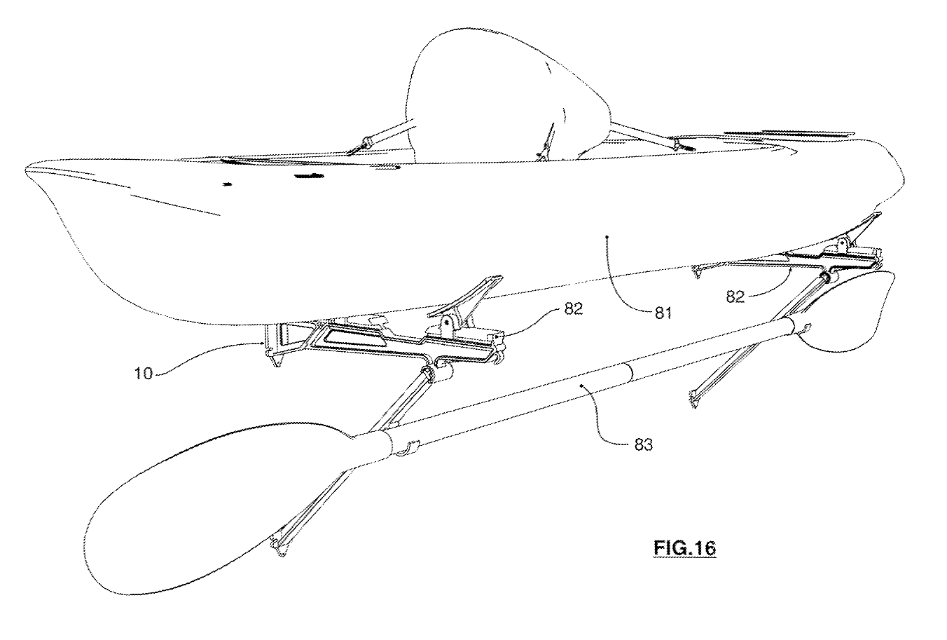

A support arm 96 is provided having a mounting bracket 98 at its one end for mounting to the support wall and a rotatable hinge formation 93 at the other end for cooperating with a complementary hinge formation 91 provided on a lower long edge of the arm 86. A holding formation 95 in the form of a hook formation is provided on the support arm 96. FIG. 16 shows the bracket assembly 80, in use, holding a kayak 81 on the rocker arms 90 and an oar 83 on the hook formations 95. It will be appreciated, that the rocker arms 90 adjust themselves in or out along sliding formations on the arm 86 of the further bracket member 82 so as to accommodate a shape of the hull of the kayak 81.

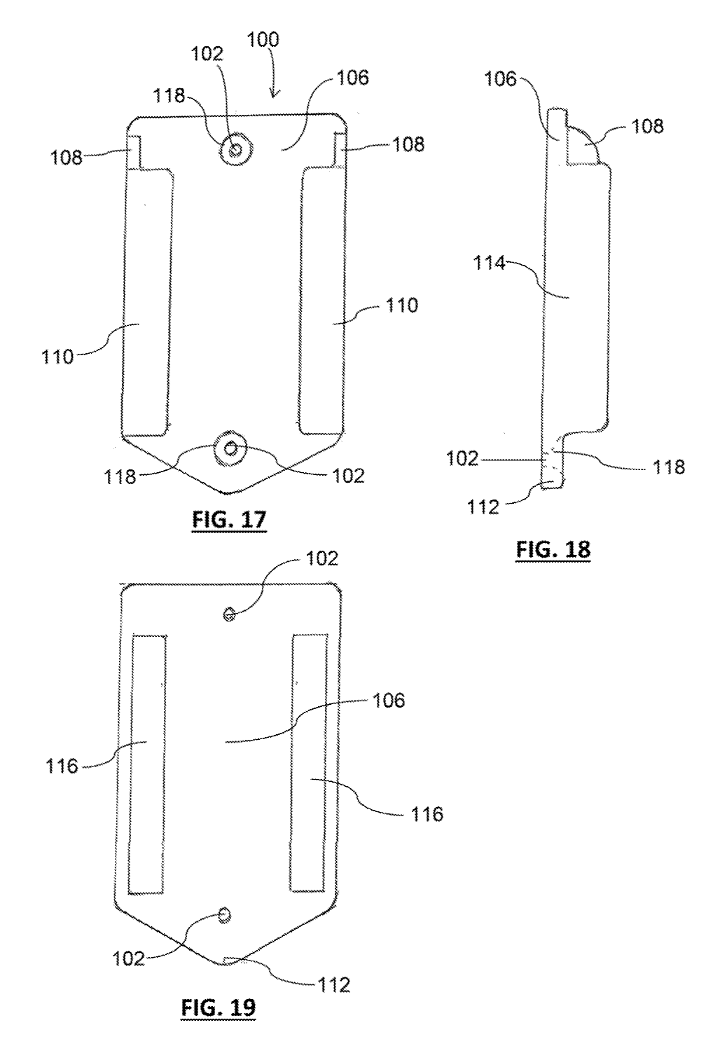

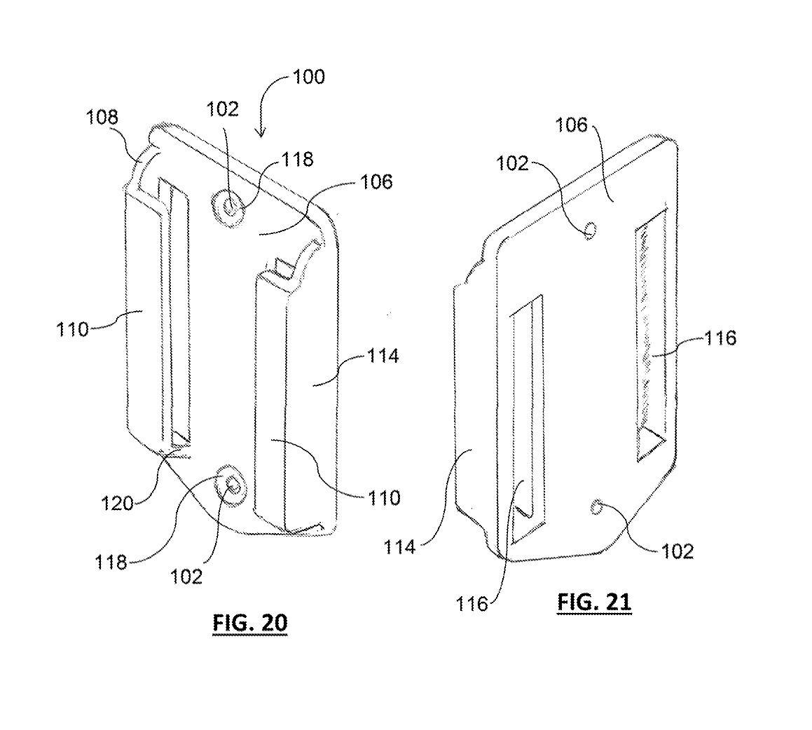

FIGS. 17 to 21 illustrates a mounting bracket 100 which provides an alternative manner of supporting at least one of the modular bracket 10 or alternatively one of the base flanges 124 in accordance with a further embodiment of the present invention. Obviously any number of mounting brackets 100 may be located in a line one under each other and spaced apart from each other. Alternatively the mounting brackets 100 may be randomly placed to suit the particular mounting arrangement required.

As shown a mounting bracket 100 having a rectangular planar base flange 106 is proved along opposite edges 114 with inwardly directed opposing L-shaped lugs 110 which define channels within which the base flange 11 of a modular bracket 10 or the sides of the base flange 124 may be slid into and captured between the lugs 110, the lugs 110 having stops 120 at their lower ends to provide support to the base flanges 11, 124. At the top of the L-shaped lugs 110 a support or guide 108 is used for guiding the base flange 11, 124 into the mounting bracket 100. Also located within the base flange 106 are longitudinally extending slots 116 which extend for substantially the length of the base flange 106.

The bracket 100 may be secured in any suitable manner to any vertical or horizontal surface such as by adhesives or by fasteners driven through apertures 102 in the base flange 106. The apertures 102 may be countersunk to form a recess 118 to allow for the flush mount of a fastener within the flange 106. The bracket 100 at the bottom side of the base flange 106 is sloped downward to form a rounded point 112 at its lowest extremity. This ensures that the fastener used at the bottom side can be easily accessed without the need for removing the modular bracket 10 or the base flange 124 from the bracket 100 when in use.

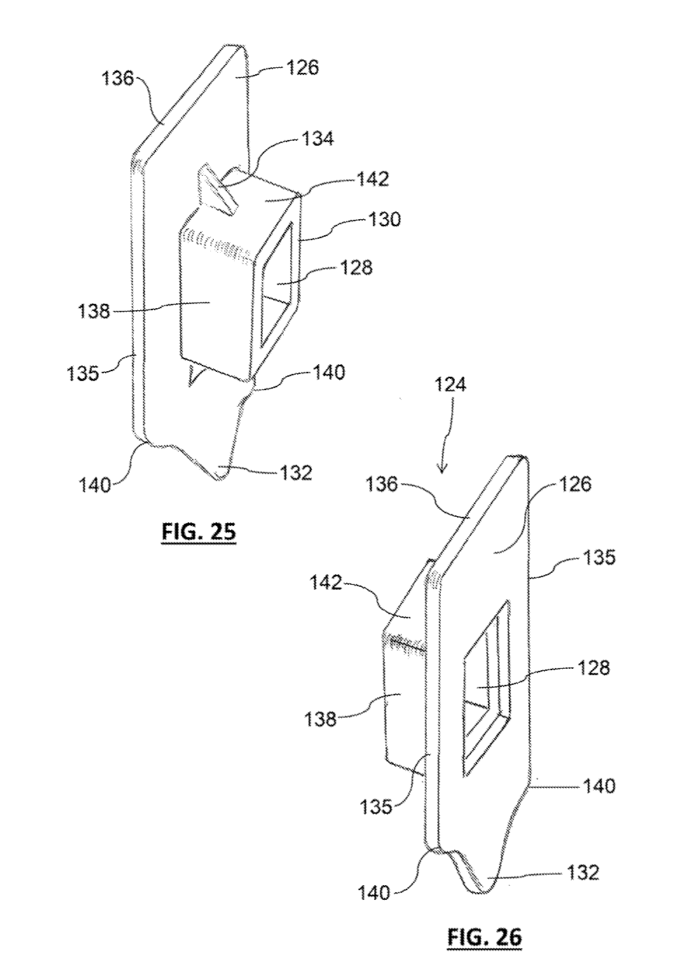

The bracket 100 may support spaced bracket assemblies of the type shown in FIGS. 4, 5, 6, 7, 8, 9, 11, 12, 13, 14, 15, 16, 22, 23, 24, 25, 26, 42 and 43.

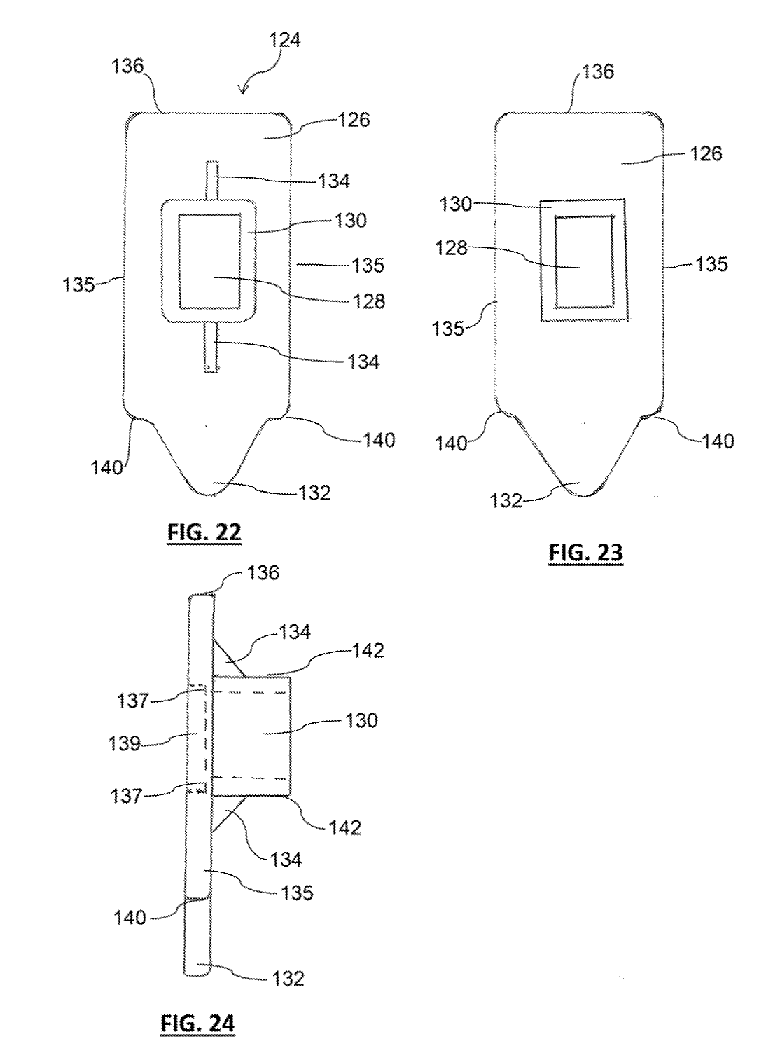

FIGS. 22 to 26 illustrate a base flange 124 which can be inserted into the mounting bracket 100. The base flange 124 includes a planar base 126, opposing sides 135, a top edge 136 and a bottom tongue 132. The bottom tongue 132 is joined to the opposing sides 135 by shoulders 140 located at one end of the sides 135 and at the other end of the sides 135 the top edge 136 joins to form the planar base 126. The opposing sides 135 are formed to insert into the L-shaped lugs 110 on the bracket 100. The tongue 132 is used to assist with sliding of the base flange 124 into and out of the bracket 100.

Located on a central portion of the planar base 126 is a raised box section 130 having opposing sides 138 and a top and bottom 142 which form a raised box section 130 with reinforcing members 134 located on the top and bottom of the box section 130. The raised box section is hollow and open at both the front and rear of the base flange 124. The front opening 128 passes through the raised box section 130. The opening 128 formed is the same size as the inside walls of the box section 130 and continues through the box section to a point located inside the planar base 126. At the rear of the planar base 126 a rectangular recess 139 is formed in the planar base 126 which has dimensions which are slightly greater than the size of the opening 128 of the raised box section 130. Therefore a shoulder 137 is formed on either side at the point where the opening 128 formed from the side of the box section 130 meets the recess 139 inside the planar base 126.

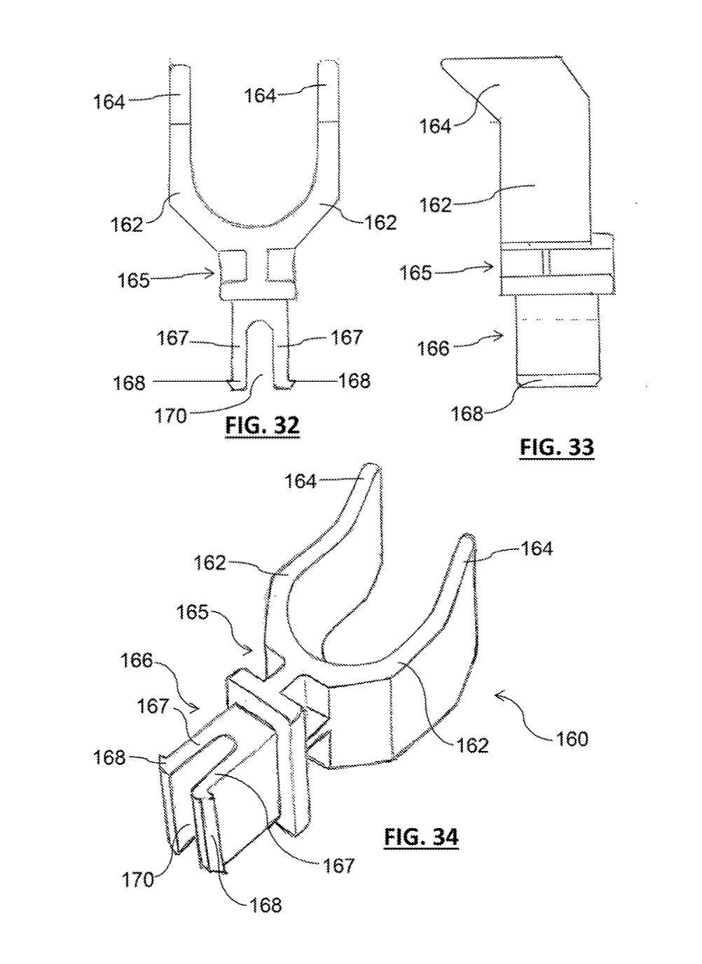

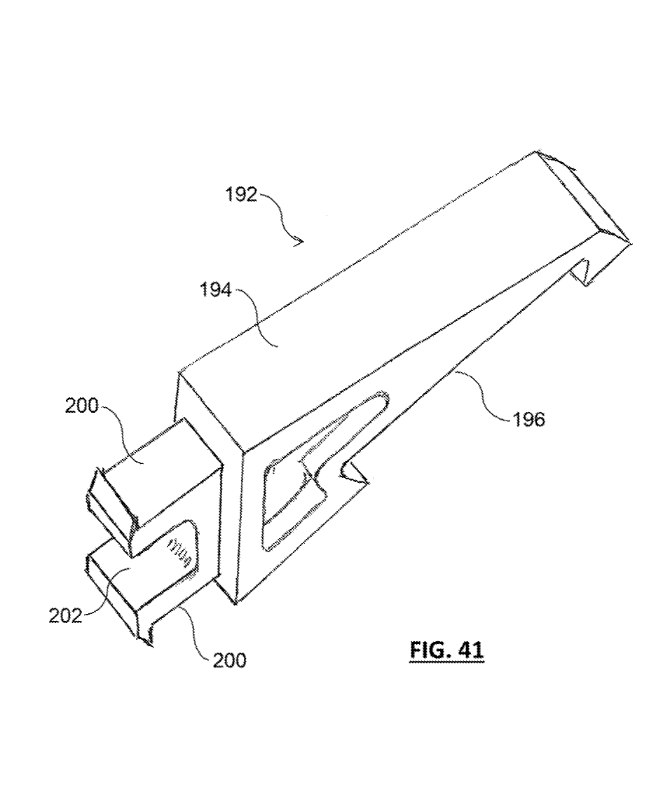

Illustrated in FIGS. 32 to 41 a complementary attachment part 160, 172, 192 can be used in combination with the base flange 124 and the mounting bracket 100. When used in this formation the mounting formation 166, 178, 198 of the complementary attachment part 160, 172, 192 is inserted into the opening 128 of the base flange 124 with the legs 167,181, 212 passing through the opening 128 and into the recess 139. When inserted in this formation the legs 167, 181, 212 are slightly compressed together so that when the legs 167, 181, 212 pass into the recess 139 the legs 167, 181, 212 are forced apart so as to form an interference fit between the legs 167, 181, 212 and the recess 139. Lugs 168, 180, 200 located at the free end of the legs 167, 181, 212 are used to secure the complementary attachment part 160, 172, 192 in position against the shoulders 137 inside the recess 139 of the base flange 124.

The shoulders 137 are formed around all four sides of the recess 139 and as is illustrated in the present embodiments the legs can be secured to the base flange 124 in one of two orientations. The orientation utilised is determined by the size and shape of the mounting formation 166, 178, 198. For example, a vertical orientation is utilised by mounting formations 166, 178 and a horizontal orientation is utilised by mounting formation 198.

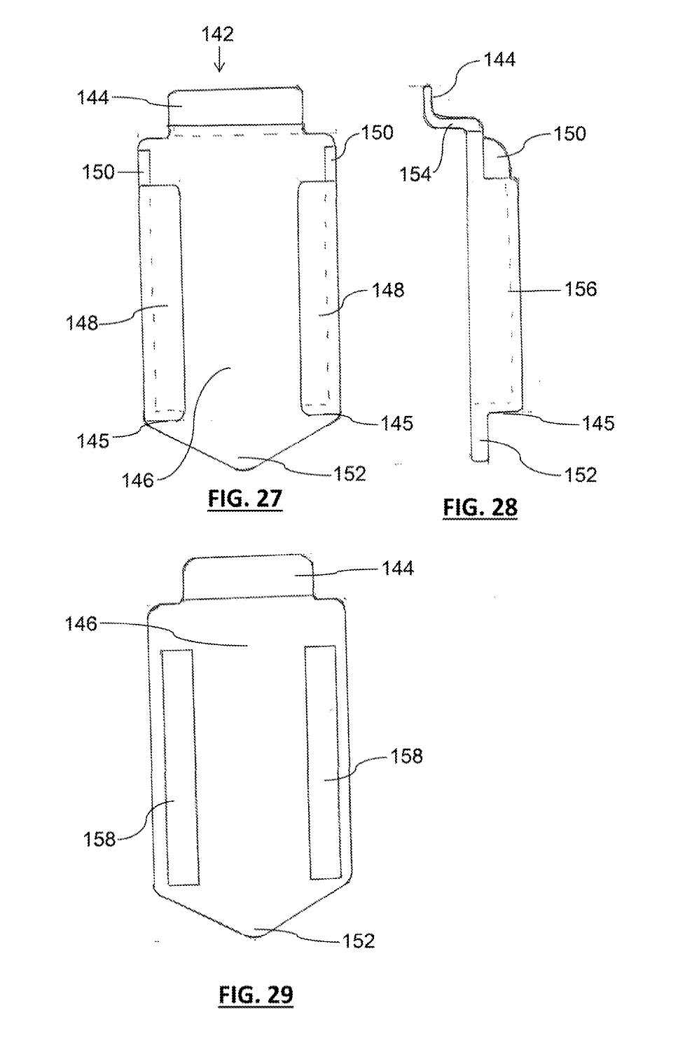

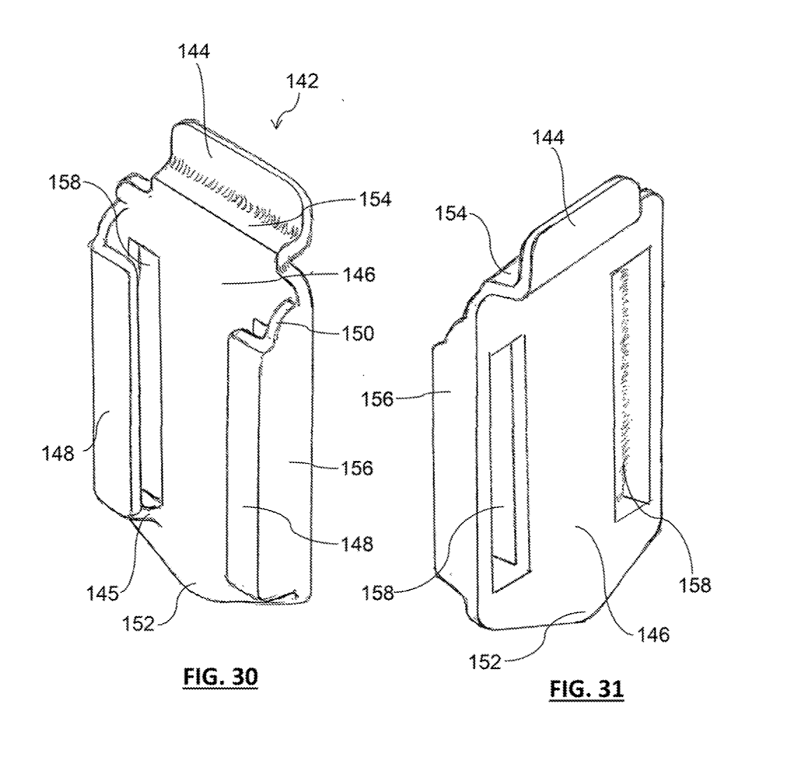

FIGS. 27 to 31 illustrate a further embodiment of the present invention in which a mounting bracket 142 is utilised to provide a further alternative manner of supporting at least one of the modular bracket 10 or alternatively one of the base flanges 124. In this embodiment the mounting bracket 142 has a rectangular planar base flange 146 is proved along opposite edges 156 with inwardly directed opposing L-shaped lugs 148 which define channels within which the base flange 11 of a modular bracket 10 or the sides of the base flange 124 may be slid into and captured between the lugs 148, the lugs 148 having stops 145 at their lower ends to provide support to the base flanges 11, 124. At the top of the L-shaped lugs 148 a support or guide 150 is used for guiding the base flange 11, 124 into the mounting bracket 142. Also located within the base flange 146 are longitudinally extending slots 158 which extend for substantially the length of the base flange 146.

In this embodiment the bracket 142 has been designed so that it can be utilised in a display wall panel or slat wall panel which provides flexible merchandising of a wide range of products and are used extensively in showrooms, retail exhibitions and displays. The panels (not shown) are grooved at intervals of approximately 100 mm or any other suitable interval. Typically the panels have aluminium inserts in each groove for the bracket 142 to hook into. In this case an L-shaped tongue 144, 154 extends from the top of the bracket 142 and the portion 144 is inserted inside the groove of the slat wall panel to secure the bracket 142 in place.

The bracket 142 at the bottom side of the base flange 146 is sloped downward to form a rounded point 152 at its lowest extremity. This tongue formation is utilised when mounting the bracket 142 into the groove of the display wall panel to facilitate the easy insertion into the groove and removal from the groove in the display panel.

As described above FIGS. 32 to 41 a complementary attachment part 160, 172, 192 can be used in combination with the base flange 124 and the mounting bracket 100. The different complementary attachment parts 160, 172, 192 are examples of some of the possible attachment parts which can be utilised for holding or supporting different components. It should be obvious to a person skilled in the art that any number of attachment parts can be designed to suit any number of different components.

In FIGS. 32 to 34 a complementary attachment part 160 is used to support a skateboard (not shown) on the holding formation 162, 164. The attachment part 160 is formed from a holding formation formed by two symmetrical arms 162, 164 joined at a central point to a T-shaped cross sectional web 165 which joins the holding formation 162, 164 to the mounting formation 166. As shown in FIG. 33 the arms consist of a straight section 162 extending from the web 165 which is joined to a raised section 164 which extends in an upright direction away from the straight section 162. In use a skateboard is placed on the straight section 162 and due to the raised section 164 the skateboard is biased towards the mounting portion 166 and suitably retained on the holding formation 162, 164.

The complementary attachment part 160 is used in combination with the base flange 124 and the mounting bracket 100. When used in this formation the mounting formation 166 of the complementary attachment part 160 is inserted into the opening 128 of the base flange 124 with the legs 167 passing through the opening 128 and into the recess 139. When inserted in this formation the legs 167 are slightly compressed together so that when the legs 167 pass into the recess 139 the legs 167 are forced apart so as to form an interference fit between the legs 167 and the recess 139. To facilitate the compression of the legs 167 a void 170 is formed between both legs 167. Lugs 168 located at the free end of the legs 167 are used to secure the complementary attachment part 160 in position against the shoulders 137 inside the recess 139 of the base flange 124.

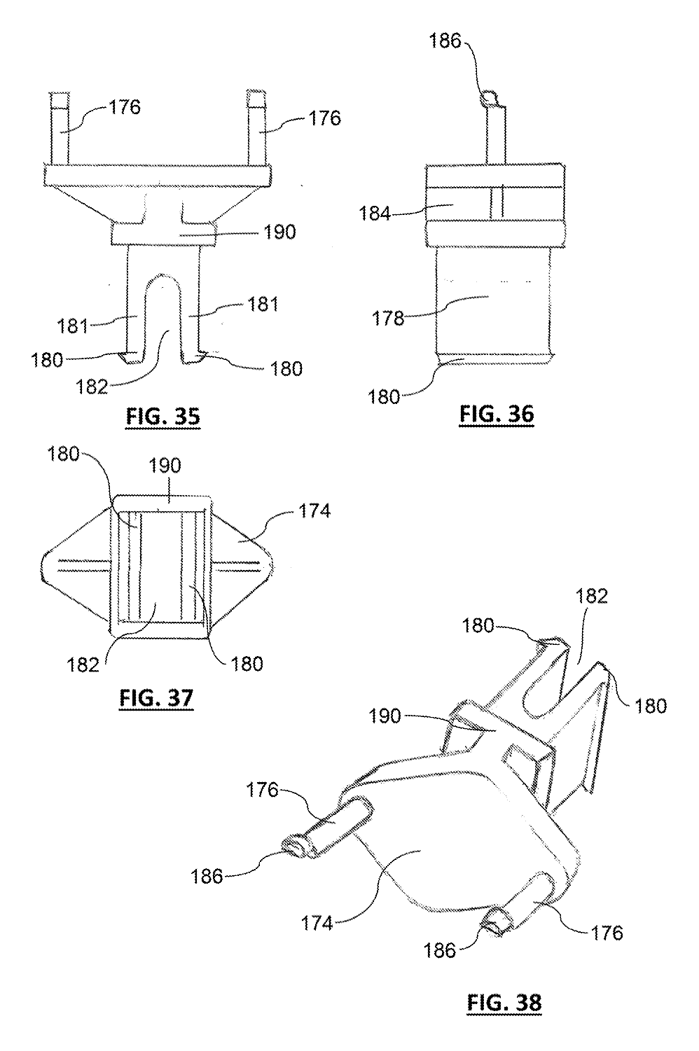

In FIGS. 35 to 38 a complementary attachment part 172 is used to support a skateboard without the truck (not shown) on the holding formation 174, 176. The posts 176 are designed to pass through the holes in the board which are formed as the attachment holes for attaching the trucks to the board. As shown in FIG. 35 the posts 176 extend from a base 174. The base 174 is joined to the web 184, 190. The complementary attachment part 172 is used in combination with the base flange 124 and the mounting bracket 100. When used in this formation the mounting formation 178 of the complementary attachment part 172 is inserted into the opening 128 of the base flange 124 with the legs 181 passing through the opening 128 and into the recess 139. When inserted in this formation the legs 181 are slightly compressed together so that when the legs 181 pass into the recess 139 the legs 181 are forced apart so as to form an interference fit between the legs 181 and the recess 139. To facilitate the compression of the legs 181 a void 182 is formed between both legs 181. Lugs 180 located at the free end of the legs 181 are used to secure the complementary attachment part 172 in position against the shoulders 137 inside the recess 139 of the base flange 124.

Located at the end of each post 176 is a further lug 186 which is utilised to locate and secure the board through the truck mounting holes. Alternatively a further securing device may be secured over the end of the lug 186 to further secure the board to the attachment part 172.

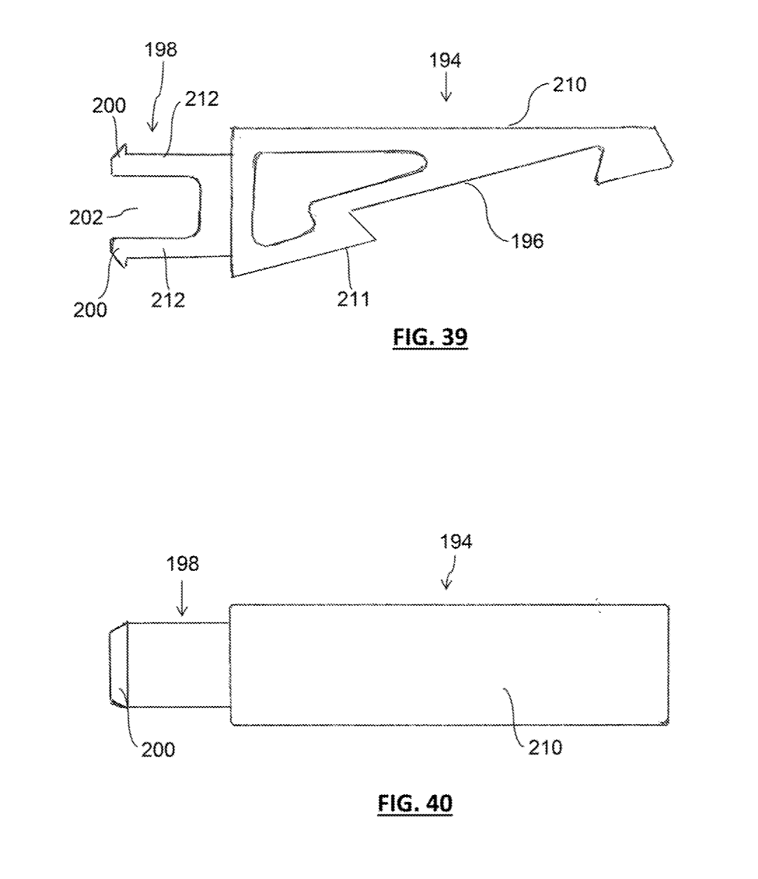

In FIGS. 39 to 41 a complementary attachment part 192 is used which is substantially similar to the modular bracket 10. Extending outwardly from the mounting portion 198 and substantially normal thereto is a first upper arm 194 and a spaced second lower arm 211 which is angled upwardly towards the upper arm 194. The top surface 210 of the upper arm 194 is sized so the arms 194, 211 are formed to be of a width which is larger than the dimensions of the mounting formation 198.

The lower arm 211 is provided with a dovetail shaped re-entrant recess 196 which has a width, the width of which extends longitudinally of the arm 211. The recess 196 is adapted to receive a complementary dovetail-shaped coupling of a further bracket assembly to be connected to the complementary attachment part 192 to adapt the complementary attachment part 192 for a number of different applications.

Like both complementary attachment parts 160, 172 the complementary attachment part 192 is used in combination with the base flange 124 and the mounting bracket 100. When used in this formation the mounting formation 198 of the complementary attachment part 192 is inserted into the opening 128 of the base flange 124 with the legs 212 passing through the opening 128 and into the recess 139. When inserted in this formation the legs 212 are slightly compressed together so that when the legs 212 pass into the recess 139 the legs 212 are forced apart so as to form an interference fit between the legs 212 and the recess 139. To facilitate the compression of the legs 212 a void 202 is formed between both legs 212. Lugs 200 located at the free end of the legs 212 are used to secure the complementary attachment part 192 in position against the shoulders 137 inside the recess 139 of the base flange 124. The only difference in the mounting formation 198 and the mounting formations 166, 178 is a horizontal orientation is utilised by mounting formation 198.

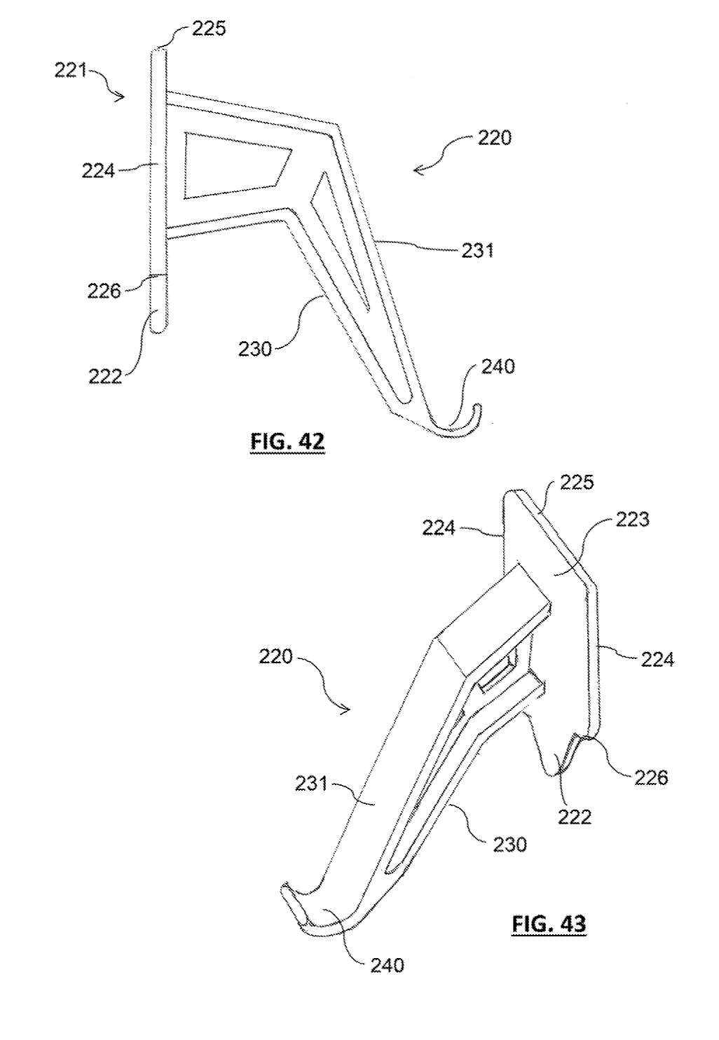

Illustrated in FIGS. 42 and 43 is a further embodiment of the present invention in which a bracket assembly 220 has been designed so that the assembly may be directly mounted into the mounting bracket 100, 142. A base flange 221 which can be inserted into the mounting bracket 100, 142. The base flange 221 includes a planar base 223, opposing sides 224, a top edge 225 and a bottom portion 222. As is apparent, the base flange 221 has a bottom portion 222 which extends downwardly below the lower arm 230 to provide additional support to the modular bracket 220 and provides ease of installation of the modular bracket 220 with the bottom portion 222 being of a triangular tapered configuration.

The bottom portion 222 is joined to the opposing sides 224 by shoulders 226 located at one end of the sides 224 and at the other end of the sides 224 the top edge 225 joins to form the planar base 223. The opposing sides 224 are formed to insert into the L-shaped lugs 110, 148 on the bracket 100,142. At the free end where the upper arm 231 joins the lower arm 230 a hook formation 240 extends from the bracket assembly 220.

While the bracket assembly 220 is illustrated other complete bracket assemblies of the types shown in FIGS. 4, 5, 6, 7, 8, 9, 11, 12, 13, 14, 15 and 16 may also be implemented in the same way as has been designed and illustrated in FIGS. 42 and 43.

While the coupling means between the bracket parts are preferably of a dovetail configuration defined by a re-entrant recess and a complementary shaped projection, other forms of coupling means may be used.

The modular bracket and the various further bracket members, advantageously provides a modular bracket which may be combined with any one of the further bracket members to form bracket assemblies for use in a number of different applications.

The terms “comprising” or “comprise” or derivatives thereof as used throughout the specification and claims are taken to specify the presence of the stated features, integers and components referred to but not preclude the presence or addition of one or more other feature/s, integer/s, component/s or group thereof.

The above has been given by way of illustrative embodiment of the invention however all variations and modifications as would be apparent to persons skilled in the art are deemed to fall within the broad scope of the invention as defined in the claims.

1. A modular bracket assembly comprising:
a first mounting part to be mounted to a surface, said first mounting part comprising a sleeve for fixably receiving a second inserting part, wherein the second inserting part comprises an aperture adapted to receive a complementary attachment part.

2. A modular bracket assembly as claimed in claim 1, wherein the aperture comprises a first coupling means.

3. A modular bracket assembly as claimed in claim 2, wherein the complementary attachment part comprises:
an arm extending from a mounting portion, the arm comprising an upper arm portion and a lower arm portion and a coupling arm portion extending between the upper arm portion and lower arm portion, the coupling arm portion incorporating a second coupling means for coupling to the first coupling means; and
a holding formation at a second end of the arm for supporting a component to form a bracket assembly.

4. A modular bracket assembly as claimed in claim 3, wherein the coupling arm portion extends between the upper arm portion and the lower arm portion at an acute angle relative to the upper arm portion and the lower arm portion is angled towards the upper arm portion in the direction of the holding formation.

5. A modular bracket assembly as claimed in claim 4, in which the first coupling means is configured to permit coupling with the second coupling means in a manner in which the holding formation extends the arm longitudinally or in a manner in which the holding formation extends at a right angle from the modular bracket.

6. A modular bracket assembly as claimed in claim 5, in which the first coupling means and the second coupling means are configured to permit coupling from a sideways direction relative to the lengthwise direction of the arm of the modular bracket.

7. A modular bracket assembly as claimed in claim 6, in which the first coupling means and the second coupling means form a dovetail joint between the arm and the second inserting part, wherein the first coupling means comprises a dovetail recess and the second coupling means comprises a complementary male dovetail, the dovetail recess being sideways open to permit coupling from a sideways direction relative to the lengthwise direction of the arm of the modular bracket.

8. A modular bracket as claimed in claim 3 wherein said holding formation comprises a hook member which terminates at the second end of the arm.

9. A modular bracket as claimed in claim 8, wherein said holding formation comprises a plurality of hook members positioned vertically one above the other or said plurality of hook members are positioned vertically staggered one above the other.

10. A modular bracket as claimed in claim 9, wherein said plurality of hook members are positioned on a return arm such that the hook members are vertically staggered towards the mounting surface of the modular bracket and the return arm at its free end terminates in a further second inserting part.

11. A pair of bracket assemblies of the type defined in claim 10, wherein said first mounting parts of said bracket assemblies being adapted to be mounted at spaced apart positions and in substantially horizontal alignment for supporting an elongated member therebetween.

12. A pair of bracket assemblies as defined in claim 11, wherein the elongated member is a fishing rod or other elongated members.

13. A modular bracket assembly as claimed in claim 3, wherein the holding formation extends the arm longitudinally to form a generally horizontal extension of the arm.

14. A modular bracket assembly as claimed in claim 13, further comprising first and second spaced apart displaceable members moveably mounted on the arm, wherein the displaceable members comprise pivotally mounted arms for holding a complementary shaped object therebetween, and a support arm with a further second inserting part at one end and a rotatable hinge at a second end, the rotatable hinge allowing the support arm to be rotated about a point on a lower side of the arm and at least one hook member is attached to an outer face of the support arm.

15. A pair of bracket assemblies as claimed in claim 14, wherein said first mounting parts of said bracket assemblies being adapted to be mounted at spaced apart positions and in substantially horizontal alignment for supporting an elongated shaped object therebetween, and the elongated shaped object is a canoe or kayak or other elongated shaped object.

16. A modular bracket assembly as claimed in claim 3, wherein the second coupling means comprises a pair of compressible legs which form an interference fit when inserted into the first coupling means, wherein the pair of legs comprises a locking portion attached at the free end of the legs for securing the second coupling means to the first coupling means.

17. A modular bracket as claimed in claim 16, wherein the holding formation further comprises a first member and a second member, the members extending in a direction away from the mounting portion.

18. A modular bracket as claimed in claim 17, wherein the first and second members are posts projecting at right angles away from the mounting part, wherein the first and second posts project through holes in a skateboard, the holes being adapted to mount a skateboard truck to a board.

19. A modular bracket assembly as claimed in claim 1, wherein the complementary attachment part includes a holding formation for, in use, holding a complementary shaped object, in which the complementary attachment part includes an arm having the second coupling means towards one end and the holding formation towards the other end, and the holding formation includes a hook formation.

20. A modular bracket assembly as claimed in claim 19, in which the complementary attachment part includes an elongated arm having the second coupling means at one end and the hook formation at the other end, the arm being oriented relative to the second coupling means so that when coupled with the first coupling means of the bracket to form the bracket assembly, the arm is inclined outwardly and downwardly relative to the modular bracket.

21. A modular bracket assembly as claimed in claim 20, in which the complementary attachment part includes an elongated arm having the second coupling means at one end and a plurality of holding formations provided on an elongated edge of the elongated arm, or the complementary attachment part includes an elongated arm having at least one holding formation provided on an elongated edge of the elongated arm, the holding formation being displaceable relative to the arm in a manner that accommodates a complementary shaped body of an object

22. A modular bracket assembly as claimed in claim 21, in which the complementary attachment part includes elongate protruding members for insertion into complimentary apertures of an item for hanging, or the complementary attachment part includes two opposing walls adapted to receive items for hanging.

23. A modular bracket, which includes:
a mounting portion adapted to be mounted to a surface;
an arm extending from the mounting portion, wherein the arm includes an upper arm portion and a lower arm portion and a coupling arm portion extending between the upper arm portion and lower arm portion, the coupling arm portion incorporating the first coupling means, the first coupling means for coupling to a further bracket member having complementary second coupling means for forming a bracket assembly.

24. A modular bracket as claimed in claim 23, in which the upper arm portion is longer than the lower arm portion and the coupling arm portion extends between the upper arm portion and the lower arm portion at an acute angle relative to the upper arm portion, wherein the lower arm portion is angled towards the upper arm portion in the direction of the coupling arm.

25. A modular bracket as claimed in claim 24, in which the first coupling means is configured to permit coupling with the second coupling means in a manner in which the further bracket member extends the arm longitudinally or in a manner in which the further bracket member extends at a right angle from the modular bracket, and the first coupling means and the second coupling means are configured to permit coupling from a sideways direction relative to the lengthwise direction of the arm of the modular bracket.

26. A modular bracket as claimed in claim 25, in which the first coupling means and second coupling means form a dovetail joint between the arm and the further bracket member, wherein the first coupling means comprises a dovetail recess and the second coupling means comprises a complementary male dovetail, the dovetail recess being sideways open to permit coupling from a sideways direction relative to the lengthwise direction of the arm of the modular bracket.

27. A modular bracket as claimed in claim 26, in which at least the upper arm portion and the lower arm portion is of a T-shaped cross section.

28. A bracket assembly, which includes:
a modular bracket as claimed in claim 1; and
a further bracket member which includes a holding formation for, in use, holding a complementary shaped object.

29. A bracket assembly a claimed in claim 28, in which the further bracket member includes an arm having the second coupling means towards one end and the holding formation towards the other end, wherein the holding formation includes a hook formation, and the further bracket member includes an elongated arm having the second coupling means at one end and the hook formation at the other end, the arm being oriented relative to the second coupling means so that that when coupled with the first coupling means of the bracket to form the bracket assembly, the arm is inclined outwardly and downwardly relative to the modular bracket.
